(19) United States
(12) Patent Application Publication
(10) Pub. No.: US 2011/0216150 A1
(43) Pub. Date: Sep. 8, 2011

(54) OPTICAL HEAD

(75) Inventors: Kazutoshi TAKAHASHI, Shizuoka-ken (JP); Koji TANIMOTO, Shizuoka-ken (JP); Kenichi KOMIYA, Kanagawa-ken (JP); Daisuke ISHIKAWA, Shizuoka-ken (JP); Hiroyuki ISHIKAWA, Shizuoka-ken (JP)

(73) Assignees: Kabushiki Kaisha Toshiba, Tokyo (JP); Toshiba Tec Kabushiki Kaisha, Tokyo (JP)

(21) Appl. No.: 13/034,492

(22) Filed: Feb. 24, 2011

Related U.S. Application Data
(60) Provisional application No. 61/320,275, filed on Apr. 1, 2010.
(60) Provisional application No. 61/310,654, filed on Mar. 4, 2010.

(51) Int. Cl. B41J 2/435; B29C 65/48

(52) U.S. Cl. 347/224; 156/285

(57) ABSTRACT

An optical head includes a light-emitting board which emits light, an attachment base which includes a first opening formed in an area overlapping the light-emitting board, a second opening formed in an area different from the area overlapping the light-emitting board and a through-hole to connect the first opening and the second opening, and to which the light-emitting board is fixed, and a lens to condense the light emitted from the light-emitting board to a photoreceptor.

### CROSS-REFERENCE TO RELATED APPLICATION(S)

This application is based upon and claims the benefit of priority from: U.S. provisional application 61/320,275, filed on Apr. 1, 2010; and U.S. provisional application 61/310,654, filed on Mar. 4, 2010; the entire contents all of which are incorporated herein by reference.

### FIELD

Embodiments described herein relate generally to an optical head for emitting light.

### BACKGROUND

An optical head emits light used for exposing a photoreceptor. The optical head includes a light-emitting board and an attachment base, and the light-emitting board is attached to the attachment base by an adhesive.

Although the light-emitting board generates heat by emission of the light, since the light-emitting board and the attachment base contact each other, the heat of the light-emitting board can be released to the attachment base. However, when a gap exists between the light-emitting board and the attachment base, it becomes difficult to release the heat of the light-emitting board to the attachment base.

### DESCRIPTION OF THE DRAWINGS

FIG. 1 is a view showing an inner structure of an image forming apparatus.

FIG. 2 is a sectional view of an optical printer head of a first embodiment.

FIG. 3 is an outer appearance view of a light-emitting board and an attachment base of the first embodiment.

FIG. 4 is an exploded view of the light-emitting board and the attachment base of the first embodiment.

FIG. 5 is a sectional view of the light-emitting board and the attachment base of the first embodiment.

FIG. 6 is an outer appearance view of a system for adhering a light-emitting board and an attachment base to each other.

FIG. 7A is a flowchart showing the procedure of adhering the light-emitting board and the attachment base to each other.

FIG. 7B is a flowchart showing the procedure of adhering the light-emitting board and the attachment base to each other.

FIG. 8 is a view for explaining a disassembling operation of an optical printer head using a disassembling tool.

FIG. 9 is a view for explaining a disassembling operation of an optical printer head using a disassembling device.

FIG. 10 is an exploded view of a light-emitting board and an attachment base of a second embodiment.

FIG. 11 is a B-B sectional view of FIG. 10.

FIG. 12 is an outer appearance view of an attachment base of a third embodiment.

FIG. 13 is a sectional view of a light-emitting board and the attachment base of the third embodiment.

### DETAILED DESCRIPTION

According to an embodiment, an optical head includes a light-emitting board which emits light, an attachment base which includes a first opening formed in an area overlapping the light-emitting board, a second opening formed in an area different from the area overlapping the light-emitting board and a through-hole to connect the first opening and the second opening, and to which the light-emitting board is fixed, and a lens to condense the light emitted from the light-emitting board to a photoreceptor.

### First Embodiment

A first embodiment will be described with reference to the drawings.

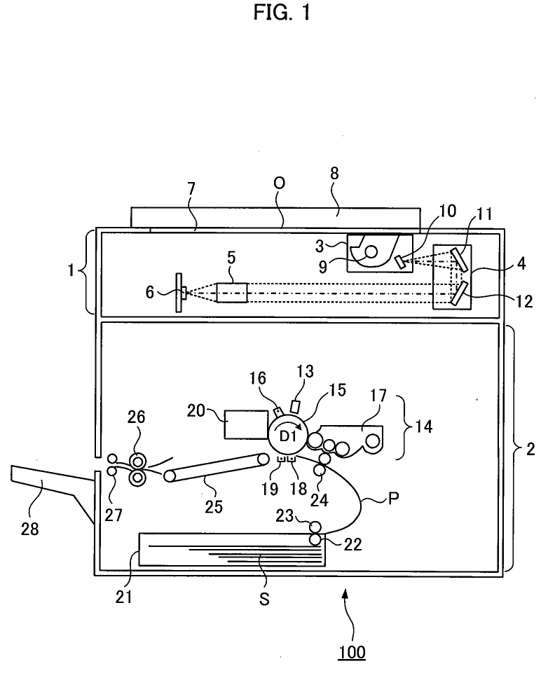

FIG. 1 is a view showing an inner structure of an image forming apparatus. The image forming apparatus 100 includes a scanner part 1 and a printer part 2. The scanner part 1 reads an image of a document O. The printer part 2 forms the image on a sheet.

The document O is placed on a document table glass 7. The read surface of the document O is directed downward and contacts the document table glass 7. A cover 8 rotates between a position where the document table glass 7 is closed and a position where the document table glass 7 is opened. When the cover 8 closes the document table glass 7, the cover 8 presses the document O to the document table glass 7.

A light source 9 emits light to the document O. The light of the light source 9 passes through the document table glass 7 and reaches the document O. The reflected light from the document O is reflected by mirrors 10, 11 and 12 in this order and is guided to a condensing lens 5. The condensing lens 5 condenses the light from the mirror 12, and forms an image on a light receiving surface of a photoelectric conversion element 6. The photoelectric conversion element 6 receives the light from the condensing lens 5 and converts it into an electric signal (analog signal).

The output signal of the photoelectric conversion element 6 is subjected to a specified signal processing, and is outputted to an optical printer head 13 which is an optical head. The specified signal processing is a processing for generating image data (digital data) of the document O. As the photoelectric conversion element 6, for example, a CCD sensor or a CMOS sensor can be used.

A first carriage 3 supports the light source 9 and the mirror 10, and moves along the document table glass 7. A second carriage 4 supports the mirrors 11 and 12, and moves along the document table glass 7. The first carriage 3 and the second carriage 4 independently move, and keep the light path length from the document O to the photoelectric conversion element 6 constant.

When the image of the document O is read, the first carriage 3 and the second carriage 4 move in one direction. While the first carriage 3 and the second carriage 4 move in the one direction, the light source 9 emits the light to the document O. The reflected light from the document O forms an image on the photoelectric conversion element 6 by the mirrors 10 to 12 and the condensing lens 5. The image of the document O is sequentially read one line by one line in the movement direction of the first carriage 3 and the second carriage 4.

The printer part 2 includes an image forming part 14. The image forming part 14 forms an image on a sheet S conveyed from a paper feed cassette 21. The plural sheets S received in the paper feed cassette 21 are separated one by one by a conveyance roller 22 and a separation roller 23, and are sent to the image forming part 14. The sheet S reaches a register roller 24 while moving along a conveyance path P. The register roller 24 moves the sheet S to a transfer position of the image forming part 14 at a specified timing.

A conveyance mechanism 25 moves the sheet S on which the image is formed by the image forming part 14 to a fixing unit 26. The fixing unit 26 heats the sheet S and fixes the image to the sheet S. A paper discharge roller 27 moves the sheet S on which the image is fixed to a paper discharge tray 28.

Next, an operation of the image forming part 14 will be described.

The optical printer head 13, a charging unit 16, a developing unit 17, a transfer charger 18, a peeling charger 19 and a cleaner 20 are disposed around a photoconductive drum 15. The photoconductive drum 15 rotates in a direction of an arrow D1.

The charging unit 16 charges the surface of the photoconductive drum 15. The optical printer head 13 exposes the charged photoconductive drum 15. The optical printer head 13 causes plural light beams to reach exposure positions of the photoconductive drum 15.

When the light beams from the optical printer head 13 reach the photoconductive drum 15, the potential at the exposure portion is lowered, and an electrostatic latent image is formed. The developing unit 17 supplies a developer to the surface of the photoconductive drum 15 and forms a developer image on the surface of the photoconductive drum 15.

When the developer image reaches the transfer position by the rotation of the photoconductive drum 15, the transfer charger 18 transfers the developer image on the photoconductive drum 15 to the sheet S. The peeling charger 19 peels the sheet S from the photoconductive drum 15. The cleaner 20 removes a developer remaining on the surface of the photoconductive drum 15.

While the photoconductive drum 15 rotates, the formation of the electrostatic latent image, the formation of the developer image, the transfer of the developer image and the cleaning of the remaining developer image can be continuously performed. That is, the operation of forming the image on the sheet S can be continuously performed.

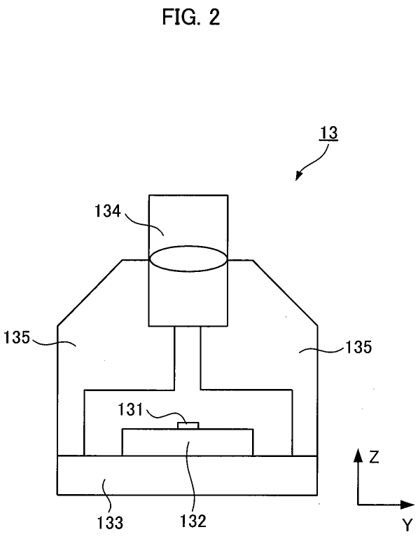

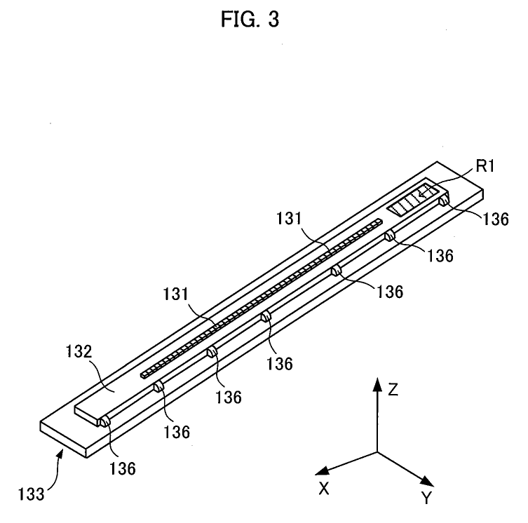

A structure of the optical printer head 13 will be specifically described with reference to FIG. 2 and FIG. 3. FIG. 2 is a sectional view of the optical printer head 13. FIG. 3 is an outer appearance view of a light-emitting board and an attachment base. In FIG. 2 and FIG. 3, an X axis, a Y axis and a Z axis are axes perpendicular to each other. Also in the other drawings, the relation among the X axis, the Y axis and the Z axis is the same.

As shown in FIG. 3, a light-emitting board 132 extends in the X direction, and includes plural light-emitting points 131. The plural light-emitting points 131 are arranged side by side in the longitudinal direction (X direction) of the light-emitting board 132. For example, when the resolution of an image formed by the image forming part 14 is 1200 dpi, 1200 light emitting points 131 per inch are provided.

As the light emitting points 131, for example, organic electroluminescence elements or LEDs (Light Emitting Diode) can be used. The light-emitting board 132 can be formed of, for example, glass. The light-emitting board 132 includes an area R1 to which a wiring line is connected, and the wiring line sends drive signals of the light-emitting points 131.

An attachment base 133 supports the light-emitting board 132, and is formed of, for example, resin or metal. When the attachment base 133 is formed of metal, it becomes easy to release the heat generated in the light-emitting board 132 at the time of light emission of the light emitting points 131 to the attachment base 133.

As shown in FIG. 3, adhesives 136 adhere the light-emitting board 132 and the attachment base 133 to each other. The adhesives 136 are applied to plural positions along the longitudinal direction (X direction) of the light-emitting board 132. The positions where the adhesives 136 are applied can be appropriately set, and the light-emitting board 132 and the attachment base 133 have only to be fixed to each other.

As shown in FIG. 2, the lights emitted from the light emitting points 131 are incident on a SELFOC lens array 134. The SELFOC lens array 134 includes plural SELFOC lenses, and the plural SELFOC lenses are arranged side by side in the longitudinal direction (X direction) of the light light-emitting board 132. The light emitted from each of the light emitting points 131 is incident on the corresponding SELFOC lens.

The SELFOC lens array 134 condenses the plural lights (diffused lights) from the plural light emitting points 131 and causes the lights to reach the exposure positions of the photoconductive drum 15. A spot light with a desired resolution is formed at the exposure position. A lens holder 135 holds the SELFOC lens array 134.

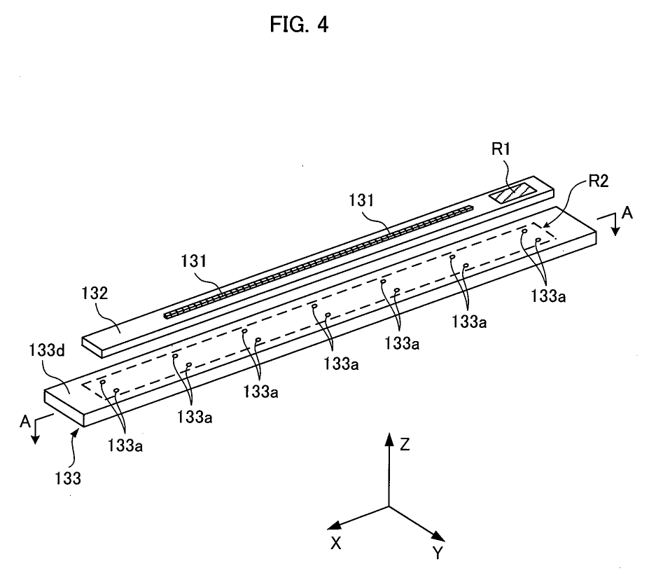

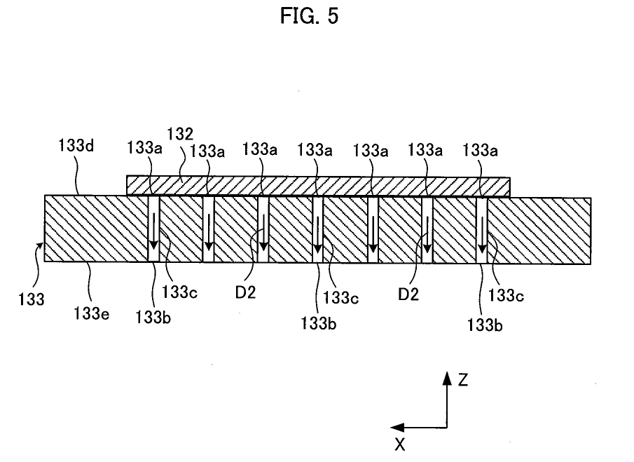

Next, a method of adhering the light-emitting board 132 and the attachment base 133 to each other will be described. FIG. 4 is an exploded view of the light-emitting board 132 and the attachment base 133. FIG. 5 is an A-A sectional view of FIG. 4.

The attachment base 133 includes a first surface 133d which contacts the light-emitting board 132 and a second surface 133e which is opposite to the first surface 133d. The first surface 133d and the second surface 133e are parallel surfaces. An area R2 included in the first surface 133d is an area which overlaps the light-emitting board 132. Plural suction ports (first openings) 133a are provided inside the area R2. The plural suction ports 133a are arranged side by side in the X direction, and are also arranged side by side in the Y direction.

The suction ports 133a have only to be provided inside the area R2, and the number and the positions of the suction ports 133a can be appropriately set. For example, the plural suction ports 133a can be arranged at random in the inside of the area R2.

The areas of the suction ports 133a may be equal to each other in the plural suction ports 133a or may be different from each other. The shapes of the suction ports 133a may also be equal to each other in the plural suction ports 133a or may be different from each other.

The first surface 133d is a flat surface. The surface of the light-emitting board 132, which contacts the attachment base 133, is a flat surface. Since the first surface 133d and the surface of the light-emitting board 132 are the flat surfaces, the light-emitting board 132 and the first surface 133d can contact each other without a gap. In this embodiment, although the whole surface of the first surface 133d is the flat surface, at least the area R2 has only to be the flat surface.

When at least one of the first surface 133d and the surface of the light-emitting board 132 is not the flat surface, a seal member can be arranged between the first surface 133d and the light-emitting board 132. When the seal member is used, as described later, when the light-emitting board 132 is adsorbed to the attachment base 133, the lowering of adsorption force can be suppressed.

Plural exhaust ports (second openings) 133b are provided on the second surface 133e of the attachment base 133. The number of the exhaust ports 133b is equal to the number of the suction ports 133a. Through-holes 133c are provided inside the attachment base 133. The through-holes 133c extend in the thickness direction (Z direction) of the attachment base 133, and connect the suction ports 133a and the exhaust ports 133b.

In this embodiment, although the through-holes 133c extend along the Z axis, they may be tilted with respect to the Z axis.

When the light-emitting board 132 is overlapped on the area R2 of the attachment base 133, and suction is performed from the suction ports 133a to the exhaust ports 133b, the light-emitting board 132 can be adsorbed to the attachment base 133. An arrow D2 shown in FIG. 5 indicates the direction of adsorption force.

When the light-emitting board 132 is adsorbed to the attachment base 133, the light-emitting board 132 and the attachment base 133 can be adhered to each other by the adhesives 136. When the adhesives 136 are hardened, the light-emitting board 132 and the attachment base 133 can be fixed.

When the light-emitting board 132 and the attachment base 133 are adhered while the light-emitting board 132 is adsorbed to the attachment base 133, the whole light-emitting board 132 can contact the attachment base 133. When the whole light-emitting board 132 contacts the attachment base 133, it becomes easy to release the heat generated in the light-emitting board 132 to the attachment base 133.

The light-emitting board 132 can be fixed along the attachment base 133, and it is possible to prevent the light-emitting board 132 from warping. When the warp of the light-emitting board 132 is prevented, it is possible to prevent the plural light-emitting points 131 from shifting in the light emission direction (Z direction).

When the positions of the plural light-emitting points 131 shift in the Z direction, the condensing characteristic of the SELFOC lens array 134 is changed, and there is a fear that variation occurs in the exposure positions of the photoconductive drum 15. In this embodiment, light path lengths from the plural light-emitting points 131 to the exposure positions of the photoconductive drum 15 can be uniformed, and the variation in the exposure positions can be prevented.

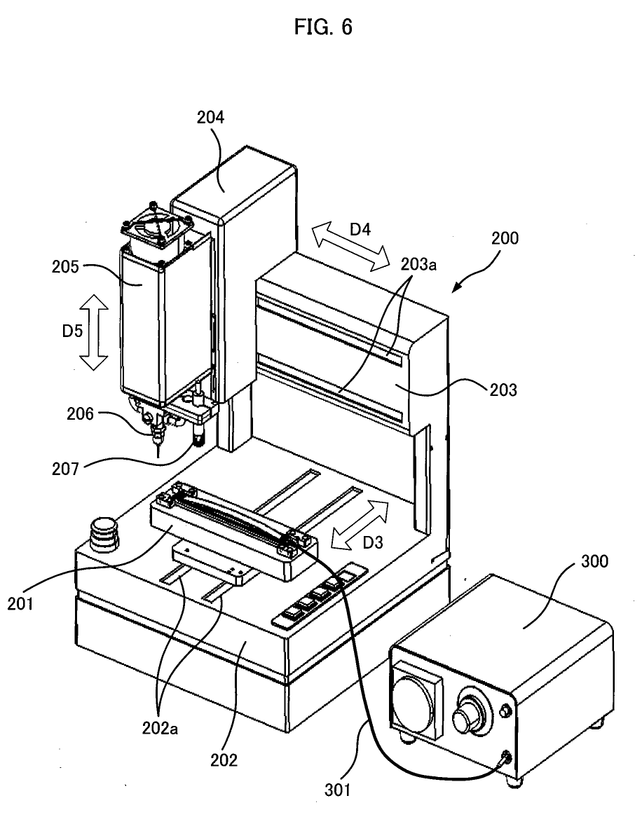

FIG. 6 shows a system for adhering the light-emitting board 132 and the attachment base 133 to each other. The system includes an adhering device 200 and a vacuum generator 300. The vacuum generator 300 includes a vacuum tube 301, and a tip of the vacuum tube 301 is connected to the attachment base 133.

A fixing part 201 of the adhering device 200 fixes the attachment base 133. The second surface 133e of the attachment base 133 contacts the fixing part 201. The fixing part 201 includes a passage for moving the air from the plural exhaust ports 133b of the attachment base 133 to the tip of the vacuum tube 301.

A first stage 202 includes a pair of guide rails 202a, and the fixing part 201 moves along the guide rails 202a in a direction of an arrow D3. A second stage 203 includes a pair of guide rails 203a, and a first moving body 204 moves along the guide rails 203a in a direction of an arrow D4.

The first moving body 204 supports a second moving body 205. The second moving body 205 moves relative to the first moving body 204 in a direction of an arrow D5. A dispenser 206 and an ultraviolet ray irradiator 207 are provided on the lower surface of the second moving body 205. The dispenser 206 applies the adhesive 136 to the light-emitting board 132 and the attachment base 133. The ultraviolet ray irradiator 207 irradiates ultraviolet rays to the adhesive 136 and hardens the adhesive 136. The adhesive 136 is the ultraviolet hardening-type adhesive.

When the second moving body 205 moves in the direction of the arrow D5, the dispenser 206 and the ultraviolet ray irradiator 207 move away from the attachment base 133 or approach the attachment base 133. When the first moving body 204 moves in the direction of the arrow D4, the dispenser 206 and the ultraviolet ray irradiator 207 move in the longitudinal direction of the attachment base 133.

When the fixing part 201 moves in the direction of the arrow D3, the adhesive 136 can be applied to a position across the light-emitting board 132.

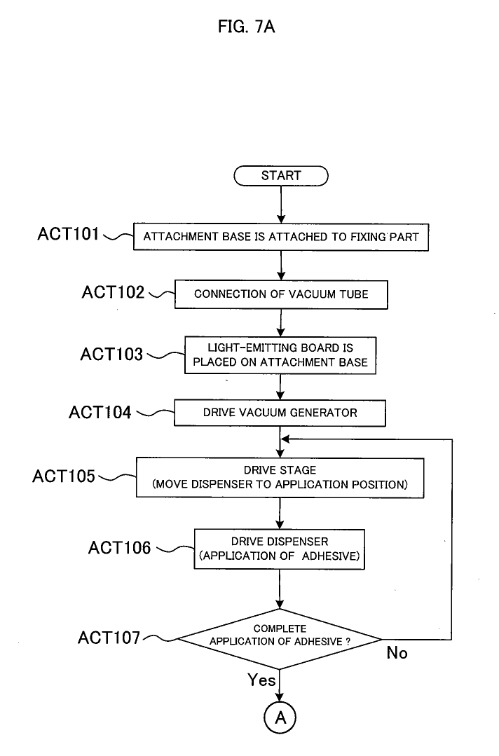

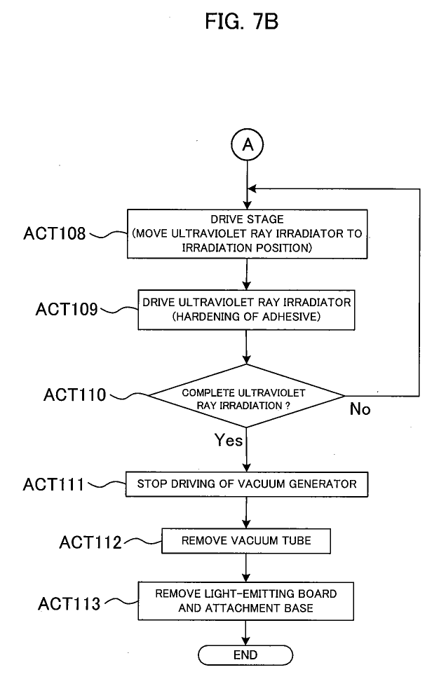

FIG. 7A and FIG. 7B are flowcharts showing the procedure of adhering the light-emitting board 132 and the attachment base 133 by using the system shown in FIG. 6.

The attachment base 133 is attached to the fixing part 201 of the adhering device 200 (ACT 101). The attachment base 133 is fixed to the fixing part 201 so that it does not shift. The tip of the vacuum tube 301 is connected to the fixing part 201 (ACT 102). The light-emitting board 132 is placed on the attachment base 133 (ACT 103). The light-emitting board 132 overlaps the area R2 of the attachment base 133. The light-emitting board 132 overlaps the area R2, so that the light-emitting board 132 closes the plural exhaust ports 133a.

The vacuum generator 300 is driven, so that suction is performed from the vacuum tube 301 (ACT 104). The light-emitting board 132 is adsorbed to the attachment base 133 by the suction force of the vacuum generator 300. When the light-emitting board 132 is adsorbed to the attachment base 133, even if an outer force is exerted on the light-emitting board 132, the light-emitting board 132 does not shift relative to the attachment base 133.

The first stage 202 and the second stage 203 are driven, so that the dispenser 206 moves to a specified application position (ACT 105). The second moving body 205 moves in the direction of the arrow D5, and the dispenser 206 approaches the light-emitting board 132 and the attachment base 133. The adhesive 136 is discharged from the tip of the dispenser 206, and adheres to the light-emitting board 132 and the attachment base 133 (ACT 106).

It is determined whether the adhesives 136 are applied to all application positions (ACT 107). When the adhesives 136 are applied to all the application positions, the applying process of the adhesive is ended. Otherwise, return is made to the process of ACT 105.

The first stage 202 and the second stage 203 are driven, so that the ultraviolet ray irradiator moves to a specified irradiation position (ACT 108). The ultraviolet ray irradiator 207 irradiates ultraviolet rays to the adhesive 136 applied to the light-emitting board 132 and the attachment base 133, and hardens the adhesive 136 (ACT 109).

It is determined whether the ultraviolet rays are irradiated to all the positions where the adhesives 136 are applied (ACT 110). When the ultraviolet rays are irradiated to all the adhesives 136, the ultraviolet ray irradiation process is ended. Otherwise, return is made to the process of ACT 108.

The driving of the vacuum generator 300 is stopped (ACT 111). The tip of the vacuum tube 301 is removed from the fixing part 201 (ACT 112). The attachment base 133 is removed from the fixing part 201 (ACT 113). The light-emitting board 132 is adhered to the attachment base 133.

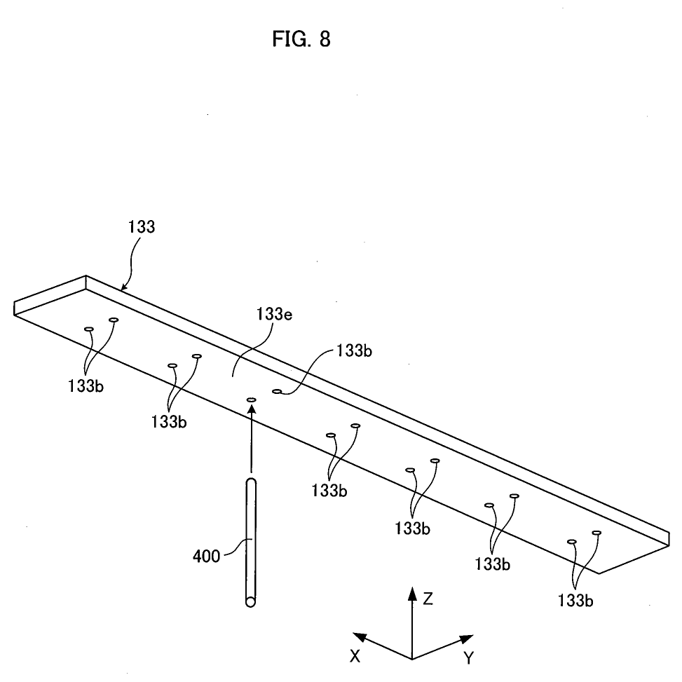

In this embodiment, the through-holes 133c of the attachment base 133 are used, so that the light-emitting board 132 and the attachment base 133 can be separated from each other. When the optical printer head 13 is recycled, the light-emitting board 132 and the attachment base 133 can be separated. A method of separating the light-emitting board 132 and the attachment base 133 will be described with reference to FIG. 8.

A disassembling tool 400 has a rod shape, and can be inserted in the exhaust port 133b. The shape of a section of the disassembling tool 400 in a direction perpendicular to the longitudinal direction may be other than a circle, and the disassembling tool 400 has only to be capable of entering the exhaust port 133b.

When one end of the disassembling tool 400 is inserted in the exhaust port 133b, the disassembling tool 400 moves in the through-hole 133c and reaches the suction port 133a. Since the suction port 133a is closed by the light-emitting board 132, the disassembling tool 400 collides with the light-emitting board 132. When the disassembling tool 400 is operated by a force larger than the adhesive force of the adhesive 136 and is pushed to the light-emitting board 132, the light-emitting board 132 can be separated from the attachment base 133.

When the adhesive 136 is applied to the vicinity of the suction port 133a, the operation force of the disassembling tool 400 can be exerted on the adhesive 136, and it becomes easy to separate the light-emitting board 132 and the attachment base 133.

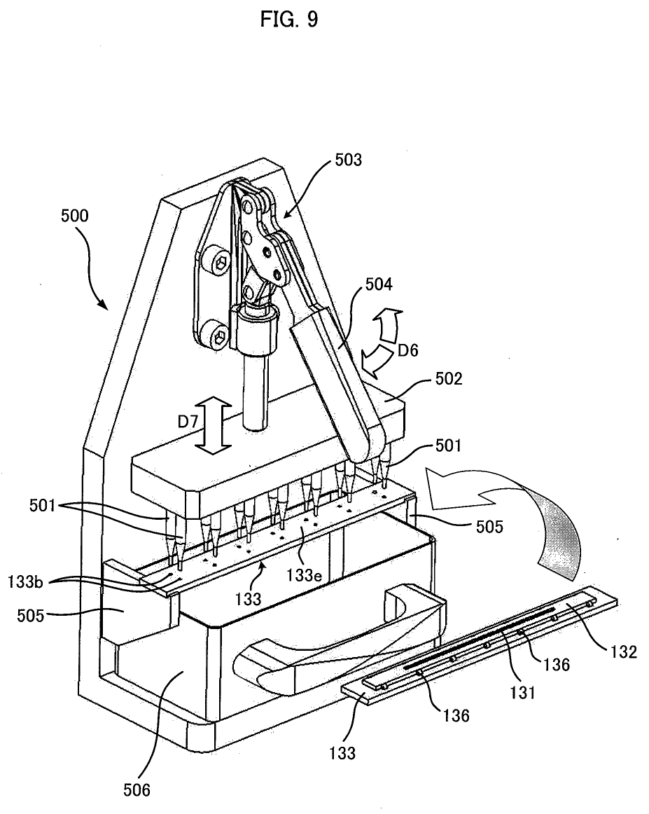

FIG. 9 shows a disassembling device for separating the light-emitting board 132 and the attachment base 133 from each other. A disassembling device 500 includes plural pushers 501. The pusher 501 has the same function as the disassembling tool 400 shown in FIG. 8. The number of the pushers 501 is the same as the number of the exhaust ports 133b.

A holder 502 holds the plural pushers 501. The holder 502 is coupled to a drive mechanism 503, and a lever 504 is coupled to the drive mechanism 503. When the lever 504 is moved in a direction of an arrow D6, the drive mechanism 503 moves the holder 502 in a direction of an arrow D7.

The attachment base 133 is placed on a pair of stands 505. The pair of stands 505 support both ends of the attachment base 133 in the longitudinal direction. When the attachment base 133 is placed on the stands 505, the exhaust ports 133b of the attachment base 133 are directed upward.

When the attachment base 133 is positioned relative to the stands 505, the pushers 501 can enter the exhaust ports 133b of the attachment base 133 when the holder 502 is lowered. When the holder 502 is lowered even after the pushers 501 pass through the through-holes 133c and contact the light-emitting board 132, the light-emitting board 132 can be separated from the attachment base 133.

A dust shoot 506 is positioned below the attachment base 133 placed on the stands 505. The dust shoot 506 receives the light-emitting board 132 peeled and dropped from attachment base 133.

When the disassembling device 500 shown in FIG. 9 is used, the light-emitting board 132 and the attachment base 133 can be separated only by moving the holder 502 in the up and down direction.

### Second Embodiment

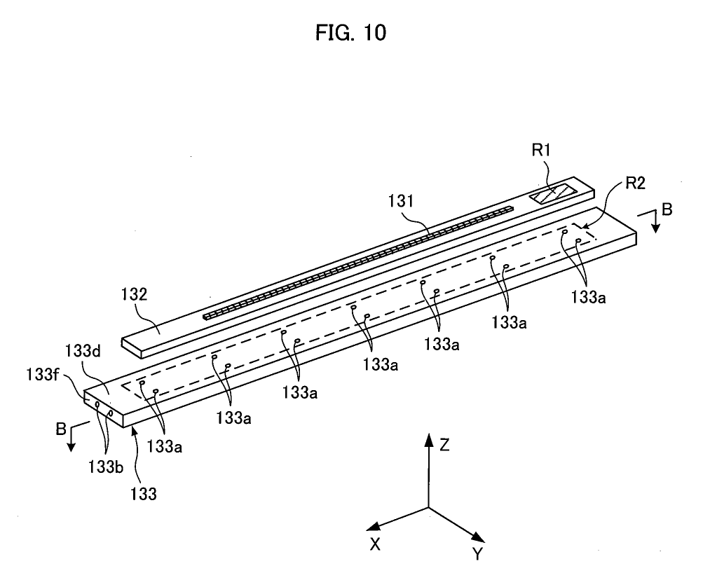

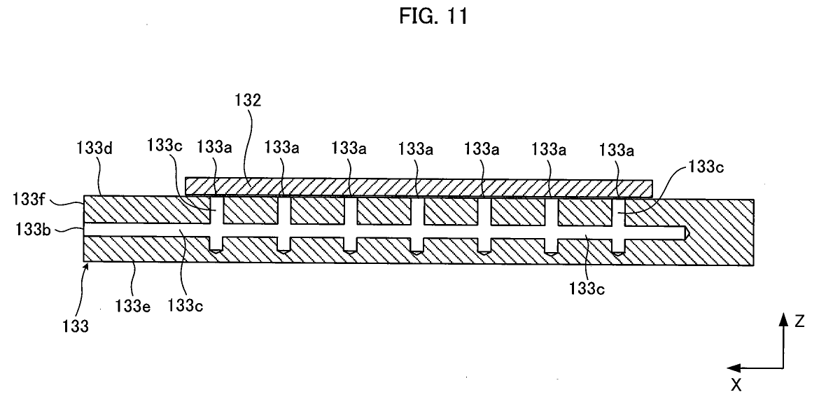

An optical printer head of a second embodiment will be described with reference to FIG. 10 and FIG. 11. FIG. 10 is an exploded view of a light-emitting board 132 and an attachment base 133, and FIG. 11 is a B-B sectional view of FIG. 10.

A first surface 133d of the attachment base 133 includes plural suction ports 133a. The number and the positions of the suction ports 133a are the same as those of the first embodiment.

A third surface 133f of the attachment base 133 includes two exhaust ports 133b. The third surface 133f is perpendicular to the first surface 133d and the second surface 133e.

A through-hole 133c extends in the X direction and the Z direction in the inside of the attachment base 133. The through-hole 133c connects the one exhaust port 133b and the plural suction ports 133a arranged side by side in the X direction. The through-hole 133c branches from the exhaust port 133b to the plural suction ports 133a.

In this embodiment, although the attachment base 133 includes the two exhaust ports 133b, the number of the exhaust ports 133b may be one or three or more. The number of the suction ports 133a and the number of the exhaust ports 133b may be different from each other. Specifically, the number of the suction ports 133a can be made larger than the number of the exhaust ports 133b. When the number of the suction ports 133a is larger than the number of the exhaust ports 133b, the through-hole 133c has only to branch from the exhaust port 133b to the suction ports 133a. On the other hand, the number of the suction ports 133a can be made smaller than the number of the exhaust ports 133b. When the number of the suction ports 133a is smaller than the number of the exhaust ports 133b, the through-hole 133c has only to branch from the suction port 133a to the exhaust ports 133b. The suction ports 133a and the exhaust ports 133b can be provided on the first surface 133d of the attachment base 133. Specifically, the suction ports 133a can be provided inside the area R2, and the exhaust ports 133b can be provided outside the area R2. The through-hole 133c has only to connect the suction port 133a and the exhaust port 133b in the inside of the attachment base 133. That is, the through-hole 133c has only to connect the suction port 133a and the exhaust port 133b.

Also in this embodiment, when suction is performed from the suction ports 133a to the exhaust ports 133b, the light-emitting board 132 can be adsorbed to the attachment base 133. While the light-emitting board 132 is adsorbed to the attachment base 133, the light-emitting board 132 and the attachment base 133 can be adhered by using adhesives.

In this embodiment, since the exhaust ports 133b are provided on the third surface 133f smaller than the second surface 133e, the tip of the vacuum tube 301 shown in FIG. 6 can be attached to the third surface 133f.

In this embodiment, although the exhaust port 133b are provided on the one end surface (third surface 133f) of the attachment base 133 in the X direction, the exhaust port 133b may be provided on both the end surfaces of the attachment base 133 in the X direction. The exhaust port 133b may be provided on one end surface or both end surfaces of the attachment base 133 in the Y direction. That is, the exhaust port 133b has only to be provided on the surface perpendicular to the first surface 133d and the second surface 133e.

In this embodiment, the number of the exhaust ports 133b can be made equal to the number of the suction ports 133a.

### Third Embodiment

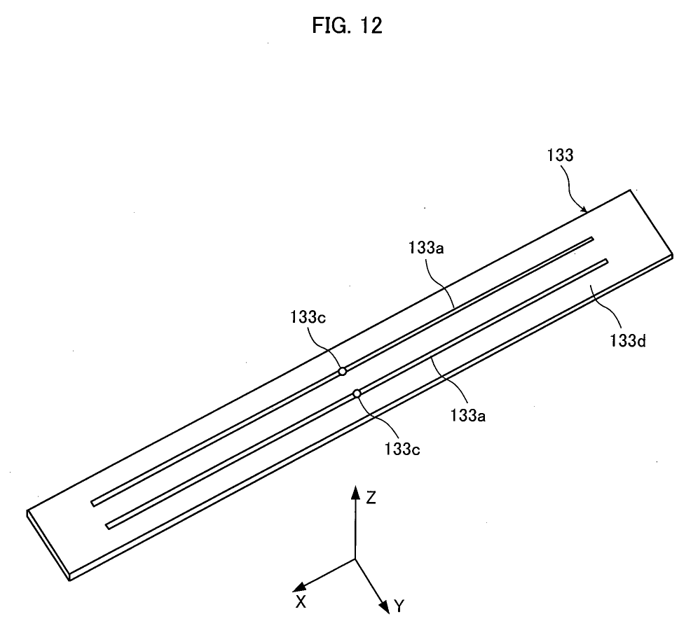

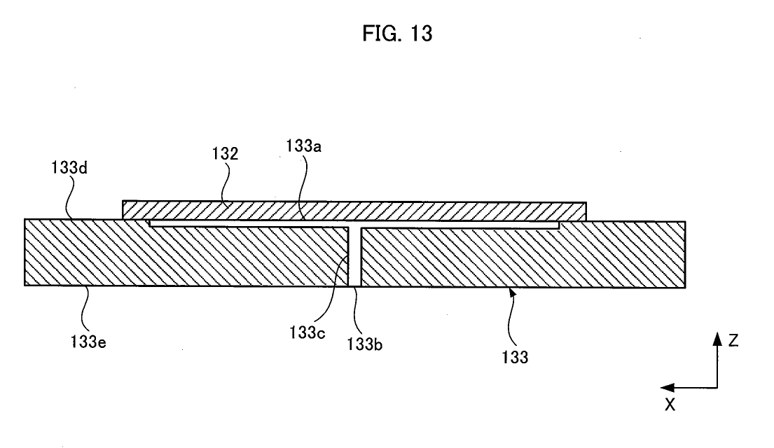

An optical printer head of a third embodiment will be described with reference to FIG. 12 and FIG. 13. FIG. 12 is an outer appearance view of an attachment base, and FIG. 13 is a sectional view of a light-emitting board and the attachment base.

A first surface 133d of the attachment base 133 includes two suction ports 133a extending in the X direction. The two suction ports 133a are arranged side by side in the Y direction. The number of the suction ports 133a may be one or three or more. The three or more suction ports 133a have only to be arranged side by side in the Y direction.

A center part of the suction port 133a in the longitudinal direction (X direction) is connected to a through-hole 133c. The through-hole 133c extends in the thickness direction (Z direction) of the attachment base 133. A second surface 133e of the attachment base 133 includes exhaust ports 133b. An area of the exhaust port 133b is smaller than an area of the suction port 133a. The number of the exhaust ports 133b is equal to the number of the suction ports 133a. The through-hole 133c connects the suction port 133a and the exhaust port 133b.

The shape of the suction port 133a is not limited to the shape shown in FIG. 12. For example, the width of the suction port 133a in the Y direction can be widened. Although the suction port 133a extends along the X axis, it may be tilted with respect to the X axis. The suction port 133a has only to be provided in an area overlapping the light-emitting board 132. A connection position of the suction port 133a and the through-hole 133c can be appropriately set.

One exhaust port 133b can be provided for the two suction ports 133a. The through-hole 133c has only to branch from the exhaust port 133b to the two suction ports 133a. The number of the suction ports 133a and the number of the exhaust ports 133b can be appropriately set, and the number of the suction port 133a can be made larger than the number of the exhaust ports 133b.

On the other hand, one suction port 133a is provided, and the plural exhaust ports 133b can be provided. The through-hole 133c has only to branch from the suction port 133a to the plural exhaust ports 133b.

In this embodiment, although the exhaust port 133b is provided on the second surface 133e, it may be provided on a surface perpendicular to the second surface 133e. That is, the exhaust port 133b may be provided at the position explained in the second embodiment.

According to this embodiment, since the suction port 133a extends in one direction, the adsorption force of the light-emitting board 132 can be increased.

While certain embodiments have been described, these embodiments have been presented by way of example only, and are not intended to limit the scope of invention. Indeed, the novel optical printer head described herein may be embodied in a variety of other forms; furthermore, various omissions, substitutions and changes in the form of the optical printer head described herein may be made without departing from the spirit of the inventions. The accompanying claims and their equivalents are intended to cover such forms or modifications as would fall within the scope and spirit of the inventions.

What is claimed is:

1. An optical head comprising:
a light-emitting board which emits light;
an attachment base which includes a first opening formed in an area overlapping the light-emitting board, a second opening formed in an area different from the area overlapping the light-emitting board and a through-hole to connect the first opening and the second opening, and to which the light-emitting board is fixed; and
a lens which condenses the light emitted from the light-emitting board to a photoreceptor.

2. The head of claim 1, wherein the light-emitting board extends in one direction.

3. The head of claim 2, wherein the first opening extends in a longitudinal direction of the light-emitting board.

4. The head of claim 3, wherein
the attachment base includes a plurality of the first openings, and
the plurality of the first openings are arranged side by side in a direction perpendicular to the longitudinal direction of the light-emitting board.

5. The head of claim 2, wherein
the attachment base includes a plurality of the first openings, and
the plurality of the first openings are arranged side by side in the longitudinal direction of the light-emitting board.

6. The head of claim 5, wherein the plurality of the first openings are arranged side by side also in a direction perpendicular to the longitudinal direction of the light-emitting board.

7. The head of claim 1, wherein the second opening is formed on a surface of the attachment base opposite to a surface on which the first opening is formed.

8. The head of claim 1, wherein the second opening is formed on a surface of the attachment base perpendicular to a surface on which the first opening is formed.

9. The head of claim 1, wherein the area of the attachment base overlapping the light-emitting board is a flat surface.

10. The head of claim 1, wherein a surface of the light-emitting board which contacts the attachment base is a flat surface.

11. The head of claim 1, wherein the number of the second openings is equal to the number of the first openings.

12. The head of claim 11, wherein the number of the through-holes is equal to the number of the first openings and the number of the second openings.

13. The head of claim 12, wherein the through-hole extends in a thickness direction of the attachment base.

14. The head of claim 1, wherein
the attachment base includes a plurality of the first openings and the one second opening, and
the through-hole branches from the second opening to the plurality of the first openings.

15. The head of claim 1, wherein
the attachment base includes the one first opening and a plurality of the second openings, and
the through-hole branches from the first opening to the plurality of the second openings.

16. The head of claim 1, wherein
the first opening is a suction port which takes in air into the through-hole, and
the second opening is an exhaust port which discharges the air from the through-hole.

17. The head of claim 1, wherein the light-emitting board and the attachment base are adhered to each other.

18. An image forming apparatus, comprising:
a photoreceptor;
a light-emitting board which emits light to the photoreceptor charged by a charging unit charging a surface of the photoreceptor;
an attachment base which includes a first opening formed in an area overlapping the light-emitting board, a second opening formed in an area different from the area overlapping the light-emitting board and a through-hole to connect the first opening and the second opening, and to which the light-emitting board is fixed;
a lens which condenses the light emitted from the light-emitting board to the photoreceptor; and
a developing unit which supplies a developer to the photoreceptor.

19. The apparatus of claim 18, further comprising:
a cassette which receives a sheet to be conveyed to the photoreceptor; and
a fixing unit which fixes a developer image to the sheet.

20. A method of manufacturing an optical head, comprising:
placing a light-emitting board which emits light on an area of an attachment base where a first opening is formed;
sucking from a second opening of the attachment base connected to the first opening through a through-hole to cause the light-emitting board to be adsorbed to the attachment base; and
adhering an adhesive to the light-emitting board and the attachment base.
